(19) United States
(12) Patent Application Publication
(10) Pub. No.: US 2004/0095370 A1
(43) Pub. Date: May 20, 2004

(54) Installation instruction system for an appliance incorporating electronic interface screen

(75) Inventors: John F. Broker, Colfax, IA (US); Douglas W. Gardner, Newton, IA (US); Eric J. Miller, Newton, IA (US); Brian L. Ness, Newton, IA (US); Alan V. Neubauer, Newton, IA (US)

Correspondence Address: DIEDERIKS & WHITELAW, PLC, #301, 12471 Dillingham Square, Woodbridge, VA, 22192, US

(73) Assignee: Maytag Corporation

(21) Appl. No.: 10/712,565

(22) Filed: Nov. 14, 2003

Related U.S. Application Data
(63) Continuation-in-part of application No. 09/919,794, filed on Aug. 2, 2001.

(51) Int. Cl. G09G 5/00

(52) U.S. Cl. 345/705

(57) ABSTRACT

An installation instruction system for an appliance employs an electronic interface screen, such as an LCD touch screen, through which a series of installation inquiries are made to a user when the appliance is initial powered. In the most preferred form of the invention, the appliance constitutes a washing machine and the sequence of installation instructions includes inquiries about the appliance being level, inlet hoses being properly connected, a drain hose being properly installed, and manufacturer supplied items being removed. The screen can also be divided into a number of panels for displaying different sets of information.

### CROSS-REFERENCE TO RELATED APPLICATIONS

The present application constitutes a continuation-in-part of U.S. patent application Ser. No. 09/919,794 filed Aug. 2, 2001, pending.

### BACKGROUND OF THE INVENTION

1. Field of the Invention

The present invention pertains to the art of appliances and, more particularly, to a system for displaying installation information through an electronic interface system of an appliance.

2. Discussion of the Prior Art

Automatic commercial washing machines have traditionally been operated from stored programs based on the positioning of various manually actuated buttons. Currently, most washing machines incorporate electronic control systems used to establish wash temperatures and time settings for the various operations performed by the washing machine. It is also known to employ a menu driven display, such as an LCD touch screen, in a washing machine or other appliance through which desired cycle information can be inputted.

One major advantage of utilizing a menu driven display over more conventional, manually actuated buttons, is that the display can be used to advantageously prompt a user for programming inputs, as basic as the type of fabric to be cleaned to the degree or level of soiling, or as complex as the desired water extraction speed and temperature. In addition to prompting the user for necessary programming information, the washing appliance can visually display a wide range of information to the user, including washing instructions and tips, as well as help information for operating and programming the washing machine. Furthermore, there is at least the potential to display diagnostic information which can be beneficial for service personnel or the like.

Given the available mounting area, a visual display on an appliance will typically need to be fairly small. For displaying basic programming information, this size is not considered problematic. However, if the system is to display other types of information, such as washing instructions and diagnostic records, there can be a considerable amount of data which needs to be presented in order to adequately convey the desired information. Under such circumstances, the available display area may simply not be adequate enough to make that information available, at least without scrolling through the information. This problem is further amplified by the fact that known displays typically designate certain areas for particular kinds of information. Under such circumstances, the entire field of the display is simply not available for relaying the wealth of information which needs to be conveyed.

An additional problem that exists in the art is that a purchased appliance, whether for home use or otherwise, may not be installed by a professional. As the operation of the appliance can be adversely affected by an improper installation, it is important to assure that at least certain installation requirements are addressed. Typically, a purchaser is expected to review and follow written installation instructions provided with the appliance. However, it cannot be guaranteed that each of these instructions will be followed which could result in non-optimal operational capabilities of the appliance.

Based on the above, there exists a need for a menu display system in an appliance which overcomes the problems of the prior art. More particularly, there exists a need for an interactive appliance display which can present a wide range of information in a limited amount of space, while enhancing the manner and amount of information that can be accessed. There specifically exists the need to employ an interactive appliance display in connection with initial appliance installation to assure that necessary instructional steps are taken to enable the appliance to operate at an optimal level.

### SUMMARY OF THE INVENTION

The present invention is directed to a display system for an appliance incorporating an electronic interface screen, wherein the display screen can be used to present a wide range of information concerning operational, diagnostic and other data concerning the appliance. Most importantly, the display is utilized to direct the appliance user through a series of installation instructions whenever the appliance is initially powered up, thereby assuring that the appliance is properly set-up for effective operation, while reducing service calls associated with installation issues.

In accordance with a preferred embodiment of the invention, the appliance is provided with an LCD screen which is driven through a menu control arrangement for enabling a sequence of installation instructions to be initially provided to a user upon plugging in the appliance. After the appliance is properly installed, the menu control arrangement can then be used to enable programming parameters to be entered by a user, as well as to access additional diagnostic and other data.

Through the appliance control screen, installation instructions are provided as part of the appliance/customer interface. Preferably, a check list or other set-up instructions would be conveyed prior to initial use of the appliance or after power to the machine has been interrupted. In accordance with the most preferred form of the invention, the consumer would be required to answer a series of questions, preferably directly through touching the LCD screen, in order to enable the machine to proceed to a run mode, e.g., prior to establishing a washing operation in the case of a clothes washing machine. Therefore, the LCD display preferably establishes the interactive communication link between the customer or other installer and the appliance to assure a correct set-up for proper machine operation.

In accordance with one embodiment of the invention, the screen is divided into a number of panels, with each panel being adapted to display a different set of information. Selecting one of the panels can result in the selected panel becoming enlarged so as to fill the entire LCD screen while, at the same time, results in additional, detailed information to be displayed. In any case, individual display screens may be selected via a separate button or by directly touching the screen itself.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a perspective view of a washing machine having an electronic interface screen and incorporating the information display system of the present invention;

FIG. 2A is a diagrammatic representation of a portion of an operating screen sequence employed in accordance with the washing machine of FIG. 1;

FIG. 2B is a diagrammatic representation of additional operating screens in the overall sequence of FIG. 2A;

FIG. 3A is a diagrammatic representation of a portion of an instructional installation sequence employed in accordance with the present invention; and

FIG. 3B is a diagrammatic representation of additional screens associated with the instructional installation sequence of the invention.

### DETAILED DESCRIPTION OF THE PREFERRED EMBODIMENT

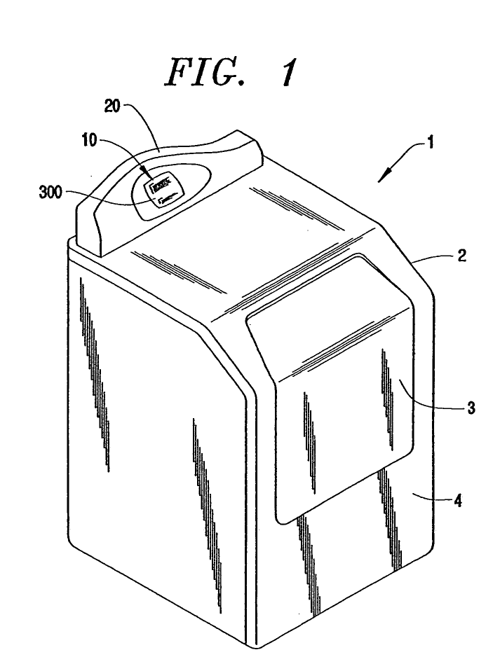

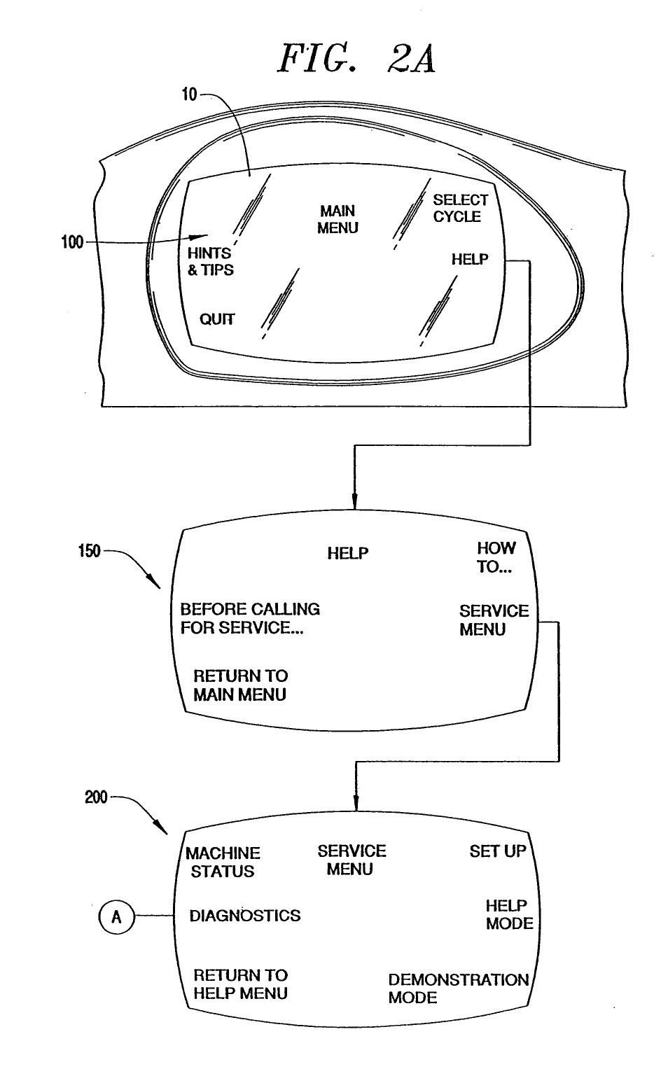

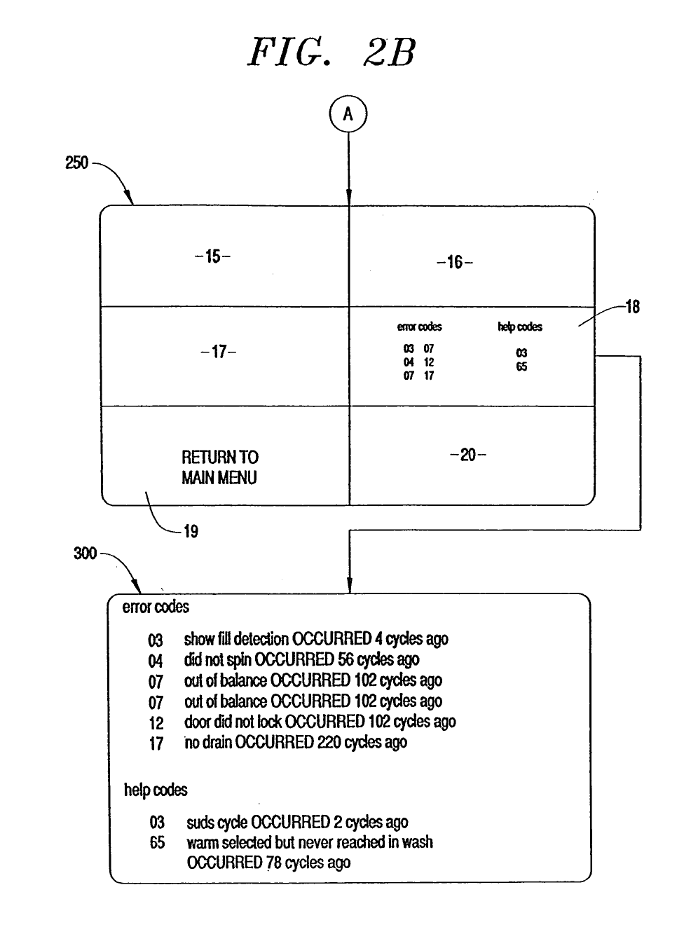

With initial reference to FIG. 1, an appliance 1 is schematically shown in the form of a washing machine. Appliance 1 includes a cabinet 2 provided with a door 3 in a front face 4. Door 3 is designed to be pivoted to expose an integral washing tub (not shown). A display 10 is provided in a control panel 20 through which a user controls and programs washing appliance 1. As will become more fully evident below, the particular construction of washing appliance 1 can significantly vary in accordance with the present invention. Display 10 includes a plurality of touch control zones in which are provided keywords (see FIG. 2A) that can be selected by a user in connection with both programming and operating washing machine 1. Actually, as shown in FIG. 2B, display 10 preferably includes six zones 15-20 as will be discussed more fully below.

In the most preferred form of the invention, display 10 takes the form of an LCD display, such as a 320×240 dot matrix, touch screen display, which enables a user to readily review displayed data, preferably in alpha or word text format, and select from that data to establish and begin a desired washing operation, as well as retrieve a wide range of information regarding appliance 1. Display 10, although shown with the various selectable zones 15-20 near or close to the corner and side portions of display 10, could have the selectable zones 15-20 at any location on the display. However, in accordance with the most preferred embodiment of the invention, zones 15-20 are preferably equal in area.

The manner in which washing appliance 1 operates in accordance with the most preferred embodiment will now be described with reference to the diagrams of FIGS. 2A and 2B. However, at this point, it should be realized that, in addition to the control options presented in these figures, appliance 1 may also include various buttons, such as a “POWER” button used to selectively turn on or off washing appliance 1, and a “BACK/CLEAR” button used to erase an inadvertently inputted control parameter through display 10. In any event, FIGS. 2A and 2B illustrate a preferred programming sequence used to illustrate the manner in which information is advantageously presented in accordance with the invention. Specifically, upon activating washing machine 1, a user is presented with screen 100. As shown, screen 100 preferably presents various operating options for washing appliance 1. With screen 100 displayed, the user can select a desired operating command, preferably by simply touching a portion of display 10 in which a key word is indicated. As shown, the user can select “Hints & Tips”, “Select Cycle”, “Help”, or “Quit” options. Details on the operation of washing appliance 1 upon selecting the “Help” option will be presented more fully below. Further operational details are disclosed in pending U.S. patent application Ser. No. 09/741,067 entitled “Interactive Control System for a Laundry Appliance”, filed Dec. 21, 2000, now U.S. Pat. No. 6,502,265, which is hereby incorporated by reference.

As indicated above, washing appliance 1 is provided with a help sequence, shown in detail in FIGS. 2A and 2B, which is activated by selecting the “Help” option from screen 100. The help sequence is initially displayed to the user in screen 150. Selecting a “How to . . . ” option from screen 150 causes washing appliance 1 to present the user with a variety of general washing procedures and suggestions for each. Screen 150 also provides the user with a “Before Calling for Service . . . ” option which can be used to present a series of commands to the user to perform before calling a service technician. These commands are designed to alleviate the necessity of calling the service technician prior to considering basic potential problem areas, such as checking the various supply and waste hoses.

A “Service Menu” option is also provided from screen 150. Selecting this option changes display 10 to give the user a variety of additional options for servicing washing appliance 1 as shown by screen 200. A “Demonstration Mode” option is available, through which the tumble action, or other washing operations, are exhibited. Additionally, a “Help Mode” option is provided which preferably presents “Help Codes”, “Extended Fill Option”, “Software Revision”, “Spinner RPM”, as well as other types of service help information.

Selecting a “Machine Status” option shows the current condition of washing appliance 1 such as the number of cycle counts. Selecting a “Set Up” option from the service menu screen 200 gives the user the ability to set up the washing operation of washing appliance 1. For instance, although not directly related to the present invention, a “Cycle Set Up” option, a “Counter Set Up” option, and a “Language Set Up” option are preferably provided as options given in the setup mode. The “Cycle Set Up” option is used to redefine one or more steps of an individual cycle, such as demonstrated in co-assigned U.S. patent application Ser. No. 09/740,977 entitled “Programmable Laundry Appliance”, filed on Dec. 21, 2000 and incorporated herein by reference. The “Counter Set Up” option is used to display and reset a running counter which calculates the number of times each cycle has been actuated and, optionally, the number of times each of the menu systems has been accessed, as well as error code counts. The “Language Set Up” option can be used to change the language which is displayed by washing appliance 1. Again, these details of the operation of washing machine 1 are disclosed in the above-referenced and incorporated pending U.S. patent applications. Therefore, this portion of the description has basically been provided for the sake of completeness.

In the embodiment shown, screens associated with the selection of a diagnostics mode of washing appliance 1 can be accessed via a “Diagnostics” option from screen 200. Although not shown, an initial screen of the diagnostics mode preferably presents the user with a “Field Test Cycle” option which runs washing appliance 1 through a specially designed diagnostic cycle to test the operation of washing appliance 1. A similar “Factory Test Cycle” option is provided, which runs washing appliance I through a different specially designed diagnostic cycle to test the operation of washing appliance 1.

Importantly, screen 250 shows error and help codes accessible through the “Diagnostics” selection. As clearly shown in this figure, error and help codes are confined to display zone 18. Although not shown, additional selectable data would actually be displayed in one or more of zones 15-17 and 20. In any event, the available area in which the error and help codes can be displayed is limited. As shown, zone 18 is actually only large enough to display coded information for the error and help data. This information is preferably collected and stored in connection with aiding a technician or other service personnel in diagnosing any operational problems associated with washing machine 1. If limited to this type of format, the technician or service personnel would have to rely upon personal knowledge, supplemental manuals or the like in order to actually determine the information being conveyed. If the data was enlarged on screen 250 to occupy additional zones 15-17 and 20, this would just limit the permissible amount of other information which could be shown without having to add one or more additional screens. Requiring the user to go through screens which contain absolutely no sought information is considered to be particularly undesirable in accordance with the invention.

To address this concern, the invention specifically provides for enlarging zone 18 to encompass the entire display 10 as represented in screen 300. At the same time, an additional layer of information is added to the display. In the embodiment shown, this additional information takes the form of expanded definitions for the error and help codes. Therefore, the data or information is preferably maintained in a hierarchical arrangement whereby expanding one of the LCD panels, e.g., the panel represented by zone 18, enables an additional layer of information to be displayed. In accordance with the invention, if details of the error and/or help codes are not needed, zone 18 will simply not be touched or otherwise selected for expansion. In this case, screen 300 is not conveyed to the user. On the other hand, if details of the error and/or help codes are needed, all of the area covered by display zones 15-20 are used to convey a full wealth of information in an efficient and effective manner. Screen 300 can be reverted back to previous screen 250 by simply touching screen 300 or, if a “BACK/CLEAR” button is provided as discussed above, by depressing the button.

Of particular concern in accordance with the present invention is assuring that appliance 1 is correctly, initially installed for optimum operation. Therefore, in accordance with the invention, upon initially powering appliance 1, display 10 is utilized to verify at least main installation parameters, preferably by directing the user through a series of check list queries or other set-up instructions. That is, prior to initial use of the appliance or after power to the machine has been interrupted, a sequence of installation instructions are presented to the user through display 10 in order to verify that appliance 1 is properly installed.

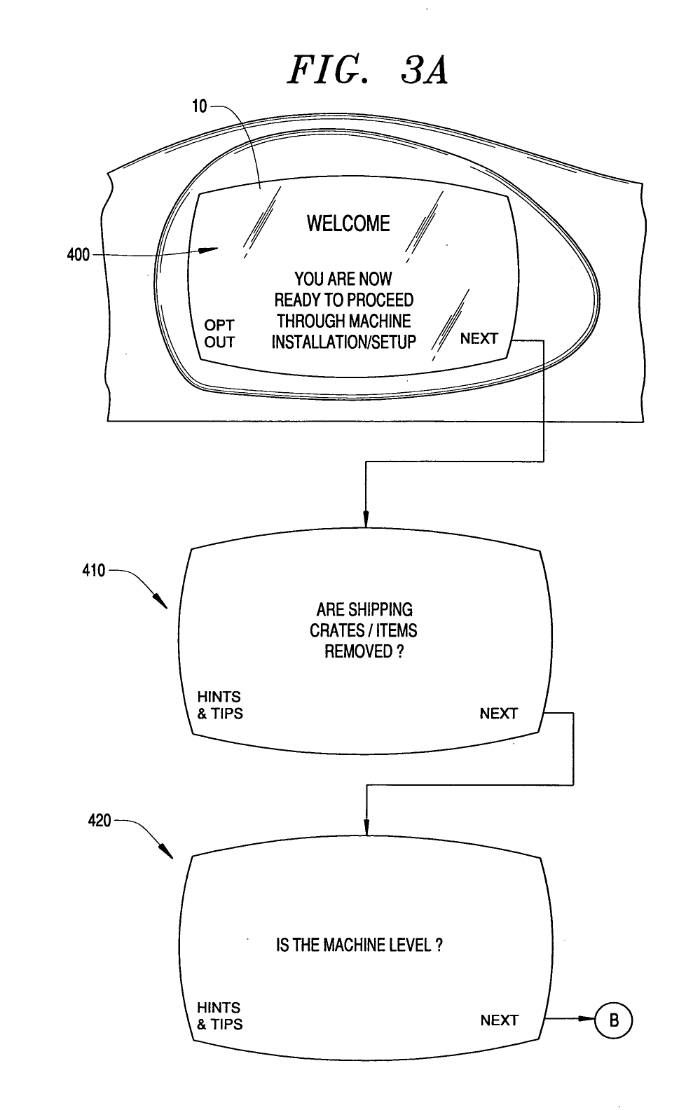

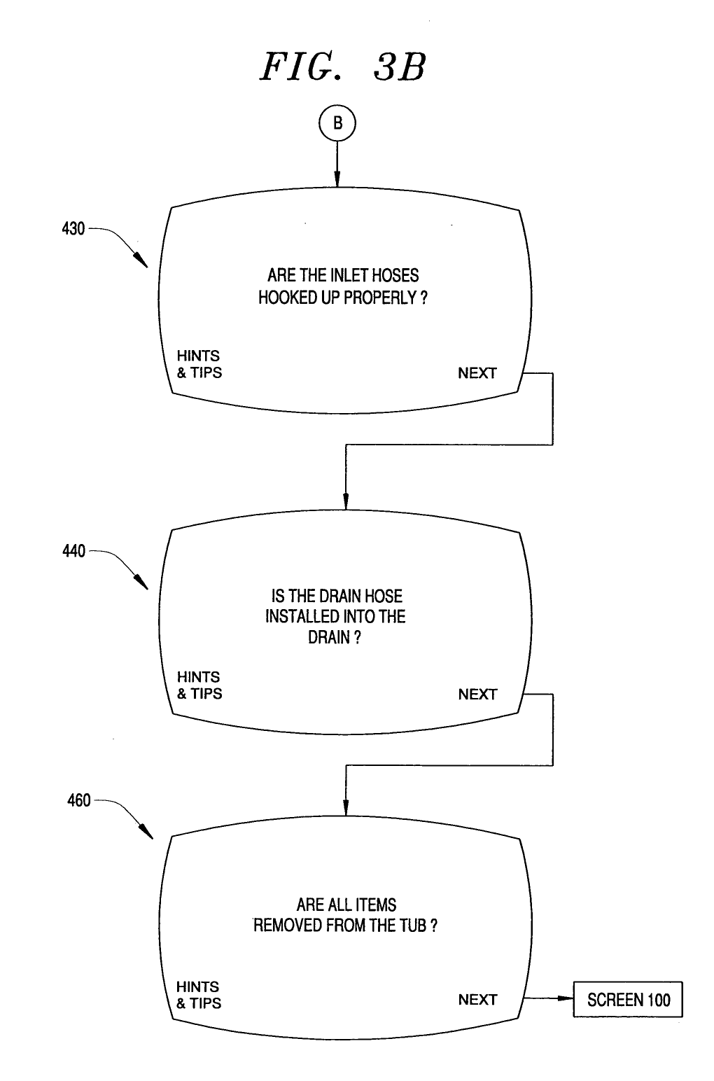

In accordance with the most preferred form of the invention, the consumer is required to answer a series of questions, preferably directly through touching the LCD screen but possibly through separate buttons (not shown), in order to enable the machine to proceed to a run mode or other main operation, e.g., prior to establishing a washing operation in the case of a clothes washing machine. Therefore, the LCD display preferably establishes the interactive communication link between the customer or other installer and appliance I to verify a correct set-up for proper machine operation. A preferred embodiment of the invention is represented in FIGS. 3A and 3B, wherein the user is directed through screens 400, 410, 420, 430, 440 and 460 before being able to reach screen 100.

In the embodiment shown, screen 400 is initially established to present a welcome note and to notify the user that a machine installation/set-up procedure should be followed. If desired, the user can opt out of the installation/set-up procedure by touching display 10 in the zone designated with “Opt Out.” However, screen 400 is preferably provided to prompt the user to proceed to the next screen of the installation/set-up procedure. In screens 410, 420, 430, 440 and 460, various checklist questions are asked, each of which must be addressed or verified by the user in order to move to a subsequent screen, with verification being preferably made by the user touching display 10 in the zone designated with “Next.” Preferably, these questions include at least inquiries about all shipping crates/items being removed, the machine being level, the inlet hoses being properly connected, the drain hose installation, and manufacturer supplied items being removed from within the appliance.

Of course, additional queries could also be made, such as questions about the electrical connection of appliance 1 and the like. In any case, the correct answering of these questions, i.e., verifying that the installation instructions have been followed, will result in proper set-up of appliance 1 for future operations. It is also preferable in accordance with the invention to present hints, tips or other helpful points to the user as needed. To this end, each of screens 410, 420, 430, 440 and 460 preferably has a potential “Hints & Tips” selection for the user wherein, if selected, enlarged zones of screen 10 will be used to explain to the user the necessary steps to be taken in order to move on to the next screen. In any case, screen 10 is divided into a number of panels for displaying at least the installation instruction, input information for the verification signal and the potential “Hints & Tips” selection.

Although described with reference to a preferred embodiment of the invention, it should be readily understood that various changes and/or modifications can be made to the invention without departing from the spirit thereof. For instance, although the information display system has been disclosed with particular reference to displaying information concerning specific installation instructional questions, as well as error and help codes for diagnostic purposes, it should be readily apparent that a wide range of information can be displayed in accordance with the present invention. In addition, although described as being incorporated within a washing machine, it should be readily apparent that the installation instruction display system of the invention could be employed in other types of appliances including clothes dryers, dishwashers, cooking appliances and refrigerators. Furthermore, although the sequence of installation is preferably displayed in various, successive screens, the sequence could be displayed on a single screen, with the user being prompted for either individual verification signals or a single verification signal. In general, the invention is only intended to be limited by the scope of the following claims.

I/We claim:

1. A method of operating an appliance comprising:
displaying an initial installation instruction of a sequence of installation instructions on a control screen of the appliance;
after receipt of a verification signal from a user of the appliance that the initial installation instruction has been followed, displaying another installation instruction of the sequence of installation instructions on the control screen; and
enabling use of the appliance for a predetermined main operation after verification has been received that additional installation instructions of the sequence of the installation instructions have been followed.

2. The method of claim 1, further comprising:
presenting each of the installation instructions on a touch screen; and
inputting each verification through the touch screen.

3. The method of claim 2, further comprising: employing an LCD display as the touch screen.

4. The method of claim 1, further comprising: establishing a washing operation as the predetermined main operation.

5. The method of claim 4, wherein the sequence of installation instructions includes inquiries about the appliance being level, inlet hoses being properly connected, a drain hose being properly installed, and manufacturer supplied items being removed.

6. The method of claim 5, further comprising: utilizing the screen to input control parameters for the predetermined main operation.

7. The method of claim 1, further comprising: enabling a user to selectively obtain additional information concerning a particular one of the sequence of installation instructions.

8. The method of claim 1, further comprising: dividing the control screen into a number of panels for separately displaying at least the installation instructions and input information for the verification signal.

9. The method of claim 1, further comprising: enabling a user to opt out of the sequence of installation instructions.

10. The method of claim 1, wherein the step of displaying the initial installation instruction only occurs after providing power to the appliance, but prior to enabling use of the appliance for the predetermined main operation.

11. An installation instruction display system for an appliance comprising:
a display device including a screen provided on the appliance;
means for displaying a sequence of installation instructions in the screen;
means for enabling a user to input a verification signal to reflect that the installation instructions have been followed; and
means for enabling the user to operate the appliance for a desired main operation after the sequence of installation instructions has been displayed.

12. The installation instruction display system according to claim 11, wherein said enabling means provides for the inputting of a separate verification signal following each installation instruction.

13. The installation instruction display system according to claim 11, wherein the display device constitutes a touch screen.

14. The installation instruction display system according to claim 11, wherein the appliance constitutes a laundry appliance.

15. The installation instruction display system according to claim 14, wherein the laundry appliance constitutes a washing machine.

16. The installation instruction display system according to claim 15, wherein the sequence of installation instructions includes inquiries about the appliance being level, inlet hoses being properly connected, a drain hose being properly installed, and manufacturer supplied items being removed.

17. The installation instruction display system according to claim 11, further comprising: means for enabling a user to selectively obtain additional information concerning a particular one of the sequence of installation instructions.

18. The installation instruction display system according to claim 11, wherein the screen is divided into a number of panels for separately displaying at least the installation instructions and verifying signal information.

19. The installation instruction display system according to claim 11, further comprising: means for enabling a user to opt out of displaying the sequence of installation instructions.
